(19) United States
(12) Patent Application Publication
(10) Pub. No.: US 2011/0104573 A1
(43) Pub. Date: May 5, 2011

(54) DEVICE FOR POWER GENERATION

(75) Inventors: Vadim Gogichev, Moscow (RU); Peter Smyslov, Moscow (RU)

(73) Assignee: PHILIPPE SAINT GER AG, Zug (CH)

(21) Appl. No.: 12/990,204

(22) PCT Filed: Apr. 24, 2009
(86) PCT No.: PCT/EP09/55006

§ 371 Date: Jan. 21, 2011

(30) Foreign Application Priority Data
Apr. 28, 2008 (CH) 273/07
Apr. 28, 2008 (CH) 662/08
Dec. 3, 2008 (CH) 1889/08

(51) Int. Cl. H01M 6/16

(52) U.S. Cl. 429/303; 29/623.1

(57) ABSTRACT

In a device (6) for power generation, having a first electrode (1) and a second electrode (2), a partition layer (3), which comprises at least one zwitterion compound and/or one radical compound, is disposed between the two electrodes (1, 2). After the two electrodes (1, 2) and the partition layer (3) are brought together, an external voltage is applied between the two electrodes (1, 2) for a specific period of time.

### TECHNICAL FIELD

The present invention relates to devices for power generation and to processes for producing devices for power generation, according to the preamble of the independent claims.

### STATE OF THE ART

Living cells contain a multitude of functionally deterministic membrane systems or complexes which are intended for various purposes, for example information processing, information transfer, generation of electrical power, synthesis of metabolites and other functions, in order to ensure the viability and normal function of the cells. Such systems are principally protein assemblies embedded into the lipid matrix of a membrane and spatially directed. Characteristic examples are: chromoproteins of halophilic bacteria (known as bacteriorhodopisin, similar to the sight system protein of mammals); visual rhodopsin, the light-sensitive photoreceptor cell pigment of the retina of vertebrates; transport adenosine triphosphatases, membrane systems for the active and energy-independent transport of ions against a gradient of their electrochemical potential; cytochrome oxidase, a last component in the respiratory chain of all aerobic organisms; Na⁺, K⁺-activated adenosine triphosphatase of plasma membranes; this energy production system, which consumes the most energy in cells, provides energy for the transport of sodium and potassium against their gradient. The content of such systems is particularly high in organs responsible for the performance of electrical work for this or any need of an organism (nerves, brain, electrical organ of a stingray, etc).

The most important structural units of the bioorganic structures listed, and others of similar function, are what are known as the transport proteins and receptor proteins. These proteins are directly involved in the transport of electrons, ions, various substances, etc. within the biosystems. The following are generally assigned to the transport proteins: cytochrome C; chlorophyll (involved in the transfer of electrons from the donor to the acceptor); oxyreductases (catalysts for redox reactions); transferases (catalysts for the transfer of various groups from one molecular to another); hemoglobin, hemocyanin and myoglobin (oxygen carriers); serum albumin (fatty acid transport in the blood), beta-lipoprotein (lipid transport), ceruloplasmin (copper transport in the blood), lipid-exchanging proteins of membranes, and many others. Examples of receptor proteins are rhodopsin of the animal sight system, and the closest related bateriorhodopsin. Rhodopsins in various biosystems act as proton pumps which directly transport various ions (H⁺, D⁺ and others) through cell membranes, and maintain an electrical potential difference over the membranes mentioned at a value which is sufficient for the survival of halophilic bacteria under extreme conditions, or for the generation of visual stimuli in animals.

The biosystems mentioned are both structurally and spatially precisely ordered, or structured, and at various levels of order. A primary structure defines a sequence of different order subunits in the chain, a secondary structure defines the folding pattern of the chain (alpha-helix, beta-structure, beta-bend or something else), and a tertiary structure is the spatial orientation of the chains. Spatial relationships and possible interactions between different separate subunits of a protein assembly are described by what is known as the quaternary structure. Membrane systems are predominantly protein assemblies composed of different subunits, characterized by all four structural hierarchies, and embedded into a lipid matrix of a membrane, in order to be exactly directed and to function as a unit. It is this extremely strict orientation of the subunits arranged in the lipid membrane which enables biosystems in vivo to have the means of directed movement (through the membrane) of electrical charge carriers within the ordered biomaterials, and also allows the generation of electrical potential differences at the limits of these biomaterials and the utilization thereof in vivo as a source of electromotive force.

The subunits of each and every protein are amino acids. Depending on the pH, each amino acid is either in the form of a polar monovalent ion (with positive or negative charge) or of a dipolar ion (zwitterion), with a protonated amino group (HN₃⁺) and deprotonated carboxyl group (COO⁻). More particularly, virtually all amino acids exist as zwitterions under neutral conditions (pH=7.0). Since such a zwitterion subunit is a particular combination of interacting atoms, for example C, O, N, H and others, and contains at least two groups with an excess (+; this is generally the protonated amino group NH₃⁺) and deficiency (−; this is generally the deprotonated carboxyl group COO⁻) of charge, such a subunit is de facto a structurally complex, functionally stable and self-sustaining element with spatially separate charges which define a corresponding electrical potential difference and electrical field strength within its area.

Since generation and maintenance of the membrane potential is vital for the fulfillment of the basic functions of a cell, the membrane structures or membrane matrices have to be formed as nonconductive, electrically insulating structures. In electrical engineering, a system which works owing to the separation of electrical charges by a nonconductive layer is known as a capacitor. Biomembranes which separate both charged atoms and molecules (ions) from bioorganic subunits like an insulating layer thus work similarly to a capacitor.

### OBJECT OF THE INVENTION

It is an object of the invention to provide a novel advantageous device for power generation, and a process for producing a device for power generation. These and other objects are achieved by a device for power generation and a process for producing such a device, according to the independent claims. Further preferred embodiments are given in the dependent claims.

### DESCRIPTION OF THE INVENTION

It has now been found that, surprisingly, a device for power generation, comprising a first electrode and a second electrode and a separating layer arranged between these electrodes, is improved when this separating layer comprises at least one zwitterionic compound and/or a free-radical compound. Such a zwitterionic compound may be an amino acid, preferably a natural amino acid. Glycine or histidine are particularly suitable. The free-radical compound is preferably stable, and has at least limited water solubility. Especially suitable are organic free radicals, for example free radicals of aromatic hydrocarbons. Particularly suitable are aromatically trisubstituted methyl radicals, for example the Ph₃C^{.} radical, i.e. triphenylmethyl. Such free radicals have an advantageous effect on the transport of electrons in the separating layer owing to the delocalized pi-systems, but also on the transport of protons owing to the binding of protons to these pi-systems.

The separating layer between the two electrodes advantageously comprises a carrier material which may be in the form of a gel or solid, among other states. A suitable example is a woven or knit made from linen or cotton, for example cotton gauze. Also particularly suitable are cellulose-containing composite materials, for example materials consisting of or comprising cellulose fibers or other high molecular weight polysaccharides, especially glucans, or else chitin (beta-1,4-linked N-acetylglucosamine). Such advantageous separating layers may be manufactured from organic raw materials, for example plant fibers. Cellulose fibers promote the formation of the inner structures in the separating layer, and hence the function of the inventive device.

A particularly suitable material for production of separating layers for an inventive device is described in Swiss patent application No. 1889/08, the content of which shall form an integral part of the disclosure of the present application.

In the advantageous method mentioned, a suitably prepared cellulose-containing material, for example a pulp of straw fibers, is subjected to a strong alternating electromagnetic field, in order to destroy the intercellular and intracellular bonds of the organic starting materials. The advantageous effect can be improved further by adding ferromagnetic particles, for example with a length of 3-5 mm and a diameter of 0.1 to 2.5 mm. The proportion of the ferromagnetic particles is, for example, 1-20 percent by weight, while the liquid content may be up to 40 percent by weight. The ferromagnetic particles in the alternating electromagnetic field promote the disintegration of the organic material.

After the production of the advantageous cellulose material, it is arranged in an inventive device in the necessary form, for example as a thin layer between the two electrodes. Subsequently, the cellulose material is dried. Additional hardening of the layer is also possible.

It is possible that the zwitterionic compounds and/or free-radical compounds of the inventive device are added to the cellulose-containing material at this early point, or the corresponding compounds can be applied later.

An inventive device for power generation thus comprises a first electrode and a second electrode and a separating layer arranged between the two electrodes. The separating layer comprises at least one zwitterionic compound and/or a free-radical compound.

The zwitterionic compound is preferably an amino acid, especially a natural amino acid, and preferably glycine or histidine. The free-radical compound in turn is preferably a stabilized organic radical, especially an aromatically trisubstituted methyl radical, and preferably triphenylmethyl or a derivative thereof.

The pH in the separating layer is preferably selected such that a maximum concentration of neutral zwitterions is present.

The first and/or the second electrode on an inventive device may consist, for example, of carbon, tin, zinc or of an organic conductor. One or both of the electrodes of the device has preferably been coated with a material suitable for cold electron emission, preferably by sputtering, vapor deposition or plasma coating.

In an advantageous embodiment of a device, the separating layer has a carrier material. This carrier material may be in the form of a gel or solid. The carrier material is preferably a textile fabric, preferably a woven or nonwoven made from cellulose, especially linen or cotton.

In a further advantageous variant, the carrier material comprises a cellulose-containing and/or chitin-containing material. The cellulose-containing and/or chitin-containing material has preferably been comminuted in an alternating electromagnetic field.

In yet a further advantageous embodiment of an inventive device, the device comprises an electrochemical cell.

In an advantageous process according to the invention for producing an inventive device for power generation, the combination of the two electrodes and the separating layer is followed by application of an external voltage between the two electrodes for a particular period. This leads to structure formation in the separating layer, which promotes the function of the inventive device.

### Performance of the Invention

### Example 1

An inventive device for power generation 6 is shown schematically in FIG. 1. Between a first electrode 1 in the form of a plate and a second electrode 2 in the form of a plate is arranged a separating layer 3 with a carrier material. The two electrodes 1, 2 consist of electrographite, and have a polished surface in order to minimize resistance. By means of contact lines, the electrodes 1, 2 are connected to a meter 4 with which the voltage and current values can be measured. The separating layer 3 consists of cotton material which has been impregnated with glycine and triphenylmethyl.

In one possible variant of the production of an inventive device, a first electrode 1 made from electrographite with a cleaned surface is arranged on a suitable nonconductive substrate 5, for example glass. The area of the first electrode 1 is 50-100 cm². A separating layer 3 of thickness 0.1 to 0.5 mm in the form of an untreated cotton-cellulose gauze is placed thereon as carrier material. If required, the woven material may also be present in several layers. For a test, the second electrode 2 made from the electrographite is placed on the separating layer 3, and the resistance and the capacitance are measured for control (>20 MOhm; 0.011-0.019 nF at 120 Hz).

A saturated solution (75.08 M) is prepared from high-purity water (conductivity 4.5-6.0 μS) and crystalline, pure glycine. The pH is adjusted to 7.0. At this value, the glycine molecules are present principally in the neutral zwitterionic state. A second triphenylmethyl radical solution is prepared analogously, the concentration of which is between 0.01% and 0.1% of the concentration of the glycine solution.

Then 0.25-0.3 microliter of the glycine solution is applied to the carrier material, and, after 1-2 minutes, 0.25-0.3 microliter of the free-radical solution. The second electrode 2 is applied, and the device is pressed onto the electrodes by external pressure. The meter 4 subsequently measured a voltage difference of ΔU=120 mV. After the application of a temporary simulation voltage to the electrodes, ΔU in a subsequent measurement rose to 140 mV.

When zinc (Zn) was used as the material for the two electrodes, the voltage difference ΔU was 60 mV, and, after the stimulation voltage had been applied, rose to 80 mV.

With an electrode pair of carbon and zinc, various separating layers were tested. When only glycine solution was used for the impregnation of the separating layer, the voltage difference ΔU was 500-510 mV, and, after the stimulation, rose to 900 mV. With the triphenylmethyl radical solution, the voltage difference ΔU was 750-760 mV, and, after the stimulation, rose to 1050 mV. When both solutions were used, in contrast, the voltage difference ΔU was already 950-990 mV, and, after the stimulation, rose to 1100 mV.

Table 1 shows, by way of example, the voltage and current values measured on an inventive power generation device for further combinations of electrodes and separating layers.

TABLE 1
Test results

| Material of | | Zwitterion | | |
|---|---|---|---|---|
| the electrodes | | and/or free | Measurements | |
| 1st electr. | 2nd electr. | radical | Voltage/V | Current/mA |
| C | Zn | Ph₃C^{.} | 0.6 | 0.3 |
| C | Zn | Ph₃C^{.} | 0.6 | 0.3 |
| C | Zn | Ph₃C^{.} | 0.6 | 0.3 |
| C | Zn | Ph₃C^{.} | 0.6 | 0.3 |
| C | Sn | Ph₃C^{.} | 0.6 | 0.2 |
| C | Sn | Ph₃C^{.} | 0.6 | 0.2 |
| C | Sn | Gly | 0.55 | 0.25 |
| C | Sn | His | 0.50 | 0.20 |
| C | Sn | Gly, His | 0.7 | 0.2 |
| C | Sn | Gly, His, Ph₃C^{.} | 0.75 | 0.55 |
| Sn | Sn | Gly, His | 0.4 | 0.03 |
| Sn | Sn | Gly | 0.1 | 0.08 |
| Sn | Sn | His, Ph₃C^{.} | 0.75 | 0.2 |
| Sn | Sn | Ph₃C^{.} | 0.8 | 0.3 |

Legend:
C: carbon;
Zn: zinc;
Ph₃C^{.}: triphenylmethyl;
Sn: tin;
Gly: glycine;
His: histidine.

In general, it can be stated that the voltage achievable depends on the type of zwitterion or free-radical compound used, on the solvent system, on the concentrations, and on the type of electrodes and the external load.

The inventive devices for power generation are particularly suitable as energy stores for loads with long run time and low power consumption, for example for medical implants.

### Example 2

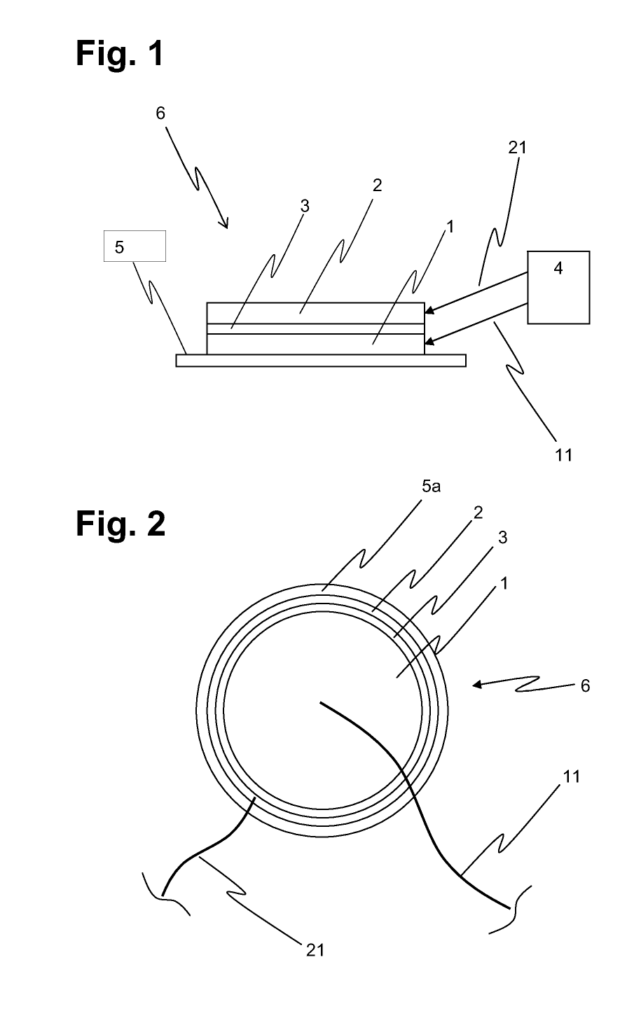

A further configuration of an inventive device is shown schematically in FIG. 2, in a cross section. The device 6 shown comprises a rod-shaped inner electrode 1, a separating layer 3 which completely surrounds the latter, and an outer electrode 2. The device is further provided with a suitable insulation layer 5a.

An experimental device according to FIG. 2 was constructed from a first electrode in the form of a rod-shaped carbon electrode 1, around which a prepared separating layer 3 was wound. The separating layer 3 consisted of cotton gauze as carrier material, which had been impregnated with a solution of 1 g of triphenylmethyl in 3 ml of water. Around this was placed a second electrode 2 in the form of a zinc sheet cuff, which surrounded the first electrode 1 and the separating layer 3 in a form-fitted and force-fitted manner. The zinc sheet cuff had a length of 15 mm in the longitudinal direction of the carbon electrode, and an internal diameter of 8.8 mm. The sheet thickness was 1 mm.

Both electrodes 1, 2 possessed electrical connections 11, 21. Finally, insulating tape 5a was wound around the device 6. After the completion of the device, a voltage U of 1.08 V was present between the two electrodes.

In another preferred embodiment, the separating layer, after the impregnation with the triphenylmethyl solution, can be dried and then wound around the first, inner electrode. After the separating layer 3 has been surrounded by the outer electrode 2, the separating layer is finally impregnated once again with triphenylmethyl solution.

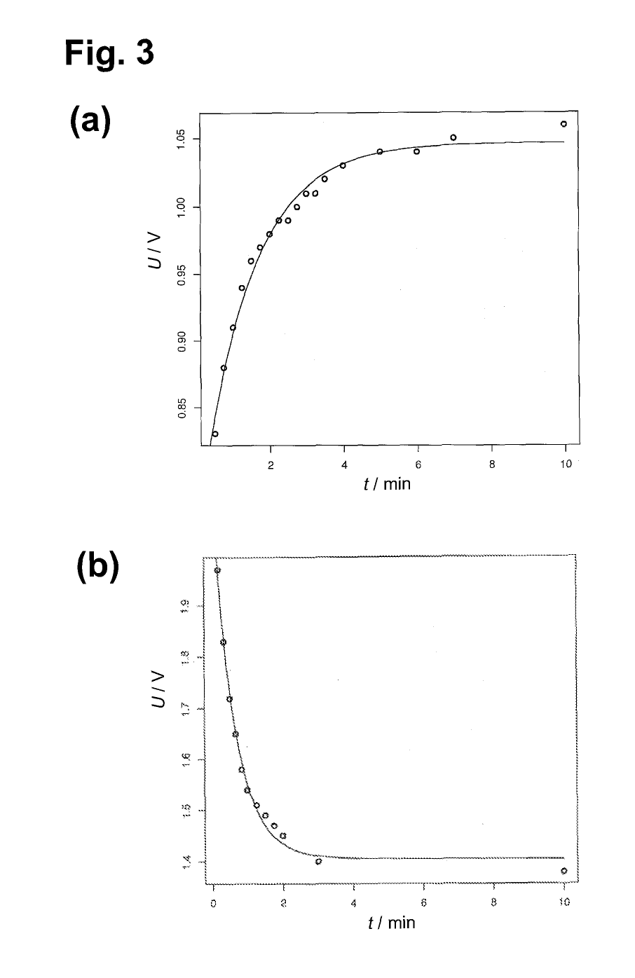

In order to measure the internal resistance Rᵢ of the inventive device, an electrolytic capacitor with a capacitance of C=470 μF, which had been fully discharged beforehand, was connected to the two electrodes of the device. The voltage U across the capacitor was recorded as a function of time t. The results are shown in FIG. 3(a).

The voltage across the capacitor is governed by the formula U=U₁(1−exp(t/RᵢC))+U₀. Fitting the test results in FIG. 3(a) gives U=0.294*(1−exp(−0.734*t))+0.752, which results in an internal resistance of the device of Rᵢ=174 kOhm (±7%).

The device was subsequently subjected to an external stimulus, and to form the desired internal structures. For this purpose, the device was connected to a voltage source with a voltage of 6.6 V for 20 seconds (plus pole to the first electrode, minus pole to the second electrode), and the current flow was limited by an appropriately selected internal resistance of the voltage source. The voltage curve measured after the stimulus is shown in FIG. 3(b). After the stimulus, the result is a higher voltage across the device.

### Example 3

A further experimental device according to FIG. 2 was constructed from a first electrode in the form of a rod-shaped carbon electrode 1, around which a prepared separating layer 3 had been wound. The separating layer 3 this time consisted of cotton gauze which had been impregnated with a solution of 20 g of glycine in 100 ml of water. Around this in turn was placed the second electrode 2 in the form of a zinc sheet cuff, which surrounded the first electrode 1 and the separating layer 3 in a form-fitting and force-fitting manner. Subsequently, insulating tape 5a was wound around the device 6. The voltage present after the completion of the device was U=1.02 V.

In another preferred variant, the separating layer is repeatedly impregnated with the glycine solution and dried, and, after the assembly of the device, the separating layer is impregnated again with the glycine solution.

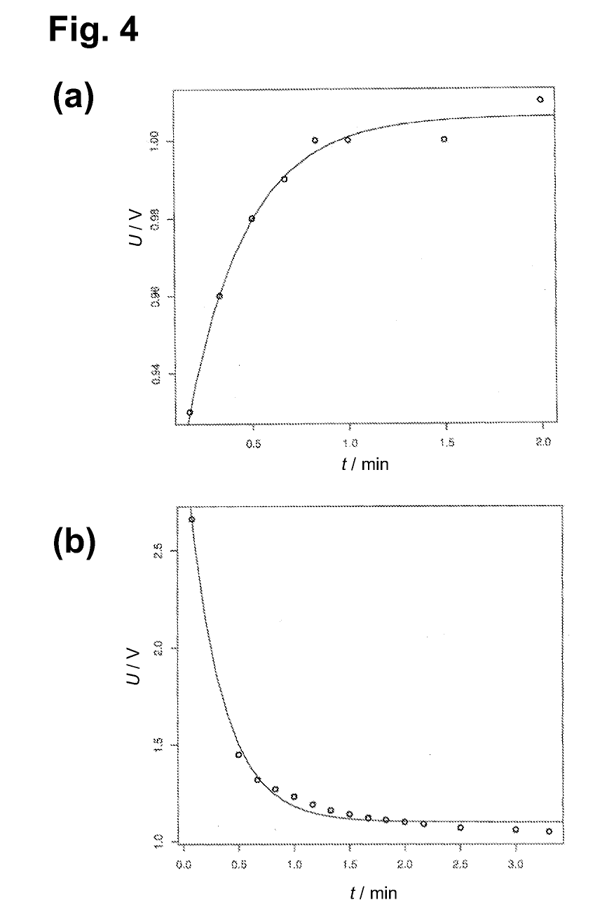

Analogously to Example 2, the internal resistance Rᵢ of the inventive device was again measured, by connecting an electrolytic capacitor having a capacitance of C=470 μF to the two electrodes of the device, and the voltage U across the capacitor was recorded as a function of time t. The results are shown in FIG. 4(a).

Fitting the abovementioned formula U=U₁(1−exp(t/RᵢC))+U₀ to the test results in FIG. 4(a) gives U=0.132*(1−exp(−0.321*t))+0.874, which gives a value of Rᵢ=40 kOhm (±11%) for the internal resistance of the device.

Analogously to Example 2, the device was likewise subjected to an external stimulus with a voltage source having a voltage of 6.6 V for a duration of 20 seconds. The voltage curve measured after the stimulus is shown in FIG. 4(b).

### Example 4

Yet a further experimental device according to FIG. 2 was constructed analogously to Example 3. The glycine solution additionally contained carboxymethylcellulose in order to optimize the adhesion to the carrier material. The resulting voltage after the assembly of the device was U=0.97 V.

The device was subsequently subjected to a stress test. For this purpose, the device was connected to a load resistance R_{L}, and the voltage U across it was measured. At R_{L}=1 MOhm the voltage was U=0.96 V, at R_{L}=560 kOhm the voltage was U=0.95 V, and at R_{L}=222 kOhm the value was U=0.92 V. At a load resistance of R_{L}=100 kOhm, the voltage stabilized after 4 minutes at U=0.79 V, which corresponds to a current flow of approx. I=8 μA.

After an external stimulus for 20 seconds with a voltage source at 9.4 V, the result after 10 minutes was a voltage across the device of U=1.55 V.

### Example 5

An inventive device was prepared analogously to Example 2, with a solution of 1 g of triphenylmethyl in 9 ml of water. The carbon electrode used is the electrode of a light arc lamp. This results in a voltage of 1.1 V. The device was subsequently subjected to an external stimulus of 8.5 V for 15 seconds. After 10 minutes, the external stimulus was repeated. After five more minutes, the result was a voltage across the device of 1.21 V.

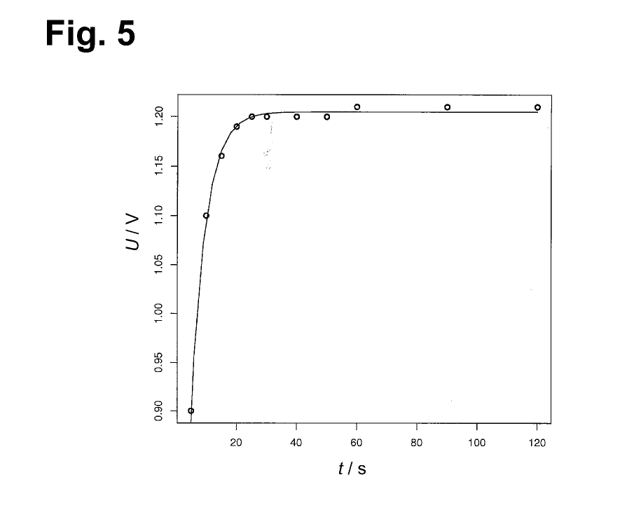

Again, the internal resistance Rᵢ of the inventive device was measured by charging an electrolytic capacitor having a capacitance of C=470 μF. The voltage U across the capacitor as a function of time t is shown in FIG. 5, with a fitted function of U=0.844*(1−exp(−0.2042*t))+0.361. The internal resistance is accordingly Rᵢ=10.4 kOhm (±4%).

1. A device for power generation, comprising a first electrode, a second electrode, and a separating layer arranged between the two electrodes, wherein the separating layer comprises at least one zwitterionic compound and/or a free-radical compound.

2. The device as claimed in claim 1, wherein the zwitterionic compound is an amino acid.

3. The device as claimed in claim 1, wherein the free-radical compound is a stabilized organic free radical.

4. The device as claimed in claim 1, wherein the separating layer comprises a carrier material.

5. The device as claimed in claim 4, wherein the carrier material is in the form of a gel or solid.

6. The device as claimed in claim 4, wherein the carrier material comprises a textile fabric.

7. The device as claimed in claim 4, wherein the carrier material comprises a cellulose-containing and/or chitin-containing material.

8. The device as claimed in claim 7, wherein the cellulose-containing and/or chitin-containing material has been comminuted in an alternating electromagnetic field.

9. The device as claimed in claim 1, wherein the device further comprises an electrochemical cell.

10. The device as claimed in claim 1, wherein the first and/or the second electrode consists of carbon, tin, zinc or an organic conductor.

11. The device as claimed in claim 1, wherein the first and/or the second electrode is coated with a material suitable for cold electron emission.

12. A process for producing a device for power generation according to claim 1, wherein combination of the two electrodes and the separating layer is followed by application of an external voltage between the two electrodes for a particular period.

13. The device as claimed in claim 2, wherein the amino acid is a natural amino acid.

14. The device as claimed in claim 13, wherein the amino acid is glycine or histidine.

15. The device as claimed in claim 3, wherein the free-radical compound is an aromatically trisubstituted methyl radical or a derivative thereof.

16. The device as claimed in claim 15, wherein the free-radical compound is triphenylmethyl or a derivative thereof.

17. The device as claimed in claim 6, wherein the carrier material comprises a woven or nonwoven fabric made from cellulose.

18. The device as claimed in claim 17, wherein the fabric is selected from the group consisting of: linen and cotton.

19. The device as claimed in claim 11, wherein the material suitable for cold electron emission is applied by sputtering, vapor deposition or plasma coating.
